(19) United States
(12) Patent Application Publication
(10) Pub. No.: US 2014/0261170 A1
(43) Pub. Date: Sep. 18, 2014

(54) METHODS FOR DETECTING AN EDGE OF A TRANSPARENT MATERIAL AND DETECTING DEVICES AND SYSTEMS FOR SAME

(71) Applicant: HiTi Digital, Inc., New Taipei (TW)

(72) Inventors: Tsung -Yueh CHEN, Taipei (TW); Chih Chieh Lin, Taipei (TW); Hui -Ting Yang, Taipei (TW)

(73) Assignee: HiTi Digital, Inc., New Taipei (TW)

(21) Appl. No.: 14/210,479

(22) Filed: Mar. 14, 2014

Related U.S. Application Data
(60) Provisional application No. 61/786,542, filed on Mar. 15, 2013.

(51) Int. Cl. G01J 1/44

(52) U.S. Cl. CPC G01J 1/44
USPC 118/668; 250/206

(57) ABSTRACT

A detecting device includes an actuating unit for driving a transparent material, a light source for emitting light to the transparent material driven by the actuating unit, a light sensor for sensing the light emitted from the light source as an edge of the transparent material is moved to different positions relative to the light source so as to generate a corresponding optical intensity signal, a transforming circuit coupled to the light sensor for transforming the optical intensity signal into a transforming signal, and a processing unit coupled to the transforming circuit for determining whether the edge of the transparent material is moved to a position between the light source and the light sensor according to the transforming signal transmitted from the transforming circuit. And methods and systems for same.

### CROSS REFERENCE TO RELATED APPLICATIONS

This application is related to and claims priority to U.S. provisional patent application, U.S. Provisional Application No. 61/786,542 filed on Mar. 15, 2013, by the applicants Chien-Hua Huang et al., entitled “Printing devices, detachable flipper module thereof and applications thereof;” and is a continuation-in-part to U.S. non-provisional patent application, application Ser. No. 13/692,975, filed on Dec. 3, 2012, by the applicants Tsung-Yueh Chen et al., entitled “Detecting Device and Method for Detecting An Edge of Transparent Material,” which claims priority to a Taiwan patent application, Application Number 101109843, filed on Mar. 22, 2012; and is also a continuation-in-part to U.S. non-provisional patent application, application Ser. No. 13/689,667, filed on Nov. 29, 2012, by the applicants Tsung-Yueh Chen et al., entitled “Detecting Device and Method for Detecting A Transparent Grating Structure,” which also claims priority to a Taiwan patent application, Application Number 101109843, filed on Mar. 22, 2012.

### BACKGROUND OF THE INVENTION

1. Field of the Invention

The present invention relates to methods for detecting an edge of a transparent material and detecting devices and systems for same, and more specifically, to methods for detecting an edge of a transparent material by level changes of an optical intensity signal and detecting devices and systems for same.

2. Description of the Prior Art

Because a transparent material whether with a grating or a flat structure has a property of transparency, a light sensor cannot sense the transparent material passing by. Generally speaking, in order to sense the transparent material by the light sensor, an opaque material can be stuck on a side of the transparent material, a shading pattern can be printed in advance, or some special transparent ink capable of shading infrared light can be printed on the transparent material, so as to detect a relative position of the transparent material by the light sensor inside a machine. However, above-mentioned mechanisms need additional process for the transparent material resulting in increase of manufacturing cost and difficulty, so that products with the transparent material as a substrate can not be widely applied in identification.

### SUMMARY OF THE INVENTION

The present invention is to provide methods for detecting an edge of a transparent material and detecting devices and systems for same to solve above problems.

According to the disclosure, a detecting device includes an actuating unit, a light source, a light sensor, a transforming circuit and a processing unit. The actuating unit is for driving a transparent material. The light source is for emitting light to the transparent material driven by the actuating unit. The light sensor is for sensing the light emitted from the light source as an edge of the transparent material is moved to different positions relative to the light source so as to generate a corresponding optical intensity signal. The transforming circuit is coupled to the light sensor for transforming the optical intensity signal into a transforming signal. The processing unit is coupled to the transforming circuit for determining whether the edge of the transparent material is moved to a position between the light source and the light sensor according to the transforming signal transmitted from the transforming circuit.

According to the disclosure, the light source is a light emitting diode, and the light sensor is an optical interrupter sensor.

According to the disclosure, the light source and the light sensor are disposed at opposite sides of the transparent material.

According to the disclosure, the light emitted from the light source is scattered by the edge of the transparent material as the edge of the transparent material is moved to the position between the light source and the light sensor so as to generate the minimum optical intensity signal by the light sensor.

According to the disclosure, the light source is a light emitting diode, and the light sensor is an optical reflective sensor.

According to the disclosure, the light source and the light sensor are disposed at the same side of the transparent material.

According to the disclosure, the light emitted from the light source is scattered by the edge of the transparent material as the edge of the transparent material is moved to the position between the light source and the light sensor so as to generate the maximum optical intensity signal by the light sensor.

According to the disclosure, the transforming circuit is for amplifying level changes of the optical intensity signal so as to generate the transforming signal.

According to the disclosure, a direction of movement of the transparent material driven by the actuating unit is substantially vertical to a direction of the light emitted from the light source.

According to the disclosure, a method for detecting an edge of a transparent material includes following steps: driving the transparent material, a light source emitting light to the transparent material, a light sensor sensing the light emitted from the light source as the transparent material is moved to different positions relative to the light source so as to generate a corresponding optical intensity signal, transforming the optical intensity signal generated by the light sensor into a transforming signal, and determining whether the edge of the transparent material is moved to a position between the light source and the light sensor according to the transforming signal.

According to the disclosure, a system capable of detecting a transparent material comprises: a detecting device which includes an actuating unit, a light source, a light sensor, a transforming circuit and a processing unit. The actuating unit is for driving a transparent material. The light source is for emitting light to the transparent material driven by the actuating unit. The light sensor is for sensing the light emitted from the light source as an edge of the transparent material is moved to different positions relative to the light source so as to generate a corresponding optical intensity signal. The transforming circuit is coupled to the light sensor for transforming the optical intensity signal into a transforming signal. The processing unit is coupled to the transforming circuit for determining whether the edge of the transparent material is moved to a position between the light source and the light sensor according to the transforming signal transmitted from the transforming circuit.

According to the disclosure, a system capable of detecting both transparent as well as non-transparent materials comprises: a detecting device which includes an actuating unit, a light source, a light sensor, a transforming circuit and a processing unit. The actuating unit is for driving a transparent material. The light source is for emitting light to the transparent material driven by the actuating unit. The light sensor is for sensing the light emitted from the light source as an edge of the transparent material is moved to different positions relative to the light source so as to generate a corresponding optical intensity signal. Based on the optical intensity signal, the detecting device may determine whether the material is transparent or non-transparent. The transforming circuit is coupled to the light sensor for transforming the optical intensity signal into a transforming signal. The processing unit is coupled to the transforming circuit for determining whether the edge of the transparent material is moved to a position between the light source and the light sensor according to the transforming signal transmitted from the transforming circuit.

According to the disclosure, a system capable of printing onto a transparent material comprises: a detecting device which includes an actuating unit, a light source, a light sensor, a transforming circuit and a processing unit. The actuating unit is for driving a transparent material. The light source is for emitting light to the transparent material driven by the actuating unit. The light sensor is for sensing the light emitted from the light source as an edge of the transparent material is moved to different positions relative to the light source so as to generate a corresponding optical intensity signal. The transforming circuit is coupled to the light sensor for transforming the optical intensity signal into a transforming signal. The processing unit is coupled to the transforming circuit for determining whether the edge of the transparent material is moved to a position between the light source and the light sensor according to the transforming signal transmitted from the transforming circuit. Based on the position determined by the processing unit, printing may be done on the transparent material.

According to the disclosure, a system capable of printing onto both a non-transparent material as well as a transparent material comprises: a detecting device which includes an actuating unit, a light source, a light sensor, a transforming circuit and a processing unit. The actuating unit is for driving a transparent or non-transparent material. The light source is for emitting light to the transparent or non-transparent material driven by the actuating unit. The light sensor is for sensing the light emitted from the light source as an edge of the transparent or non-transparent material is moved to different positions relative to the light source so as to generate a corresponding optical intensity signal. Based on the optical intensity signal, the detecting device may determine whether the material is transparent or non-transparent. For a non-transparent material, normal printing resumes. For a transparent material, the transforming circuit is coupled to the light sensor for transforming the optical intensity signal into a transforming signal. The processing unit is coupled to the transforming circuit for determining whether the edge of the transparent or non-transparent material is moved to a position between the light source and the light sensor according to the transforming signal transmitted from the transforming circuit.

The detecting devices and systems as well as the detecting methods of the present invention can utilize the light sensor and the transforming circuit to detect and locate the edge of the transparent material directly for following locating procedure. There is no need to execute additional process on the transparent material to achieve the purpose of sensing the transparent material by the light sensor. As a result, the manufacturing cost and difficulty can be reduced, and products with the transparent material as a substrate can be widely applied in identification.

The transparent material in accordance with the present invention may be an even or a grating structure. The present invention may apply to all transparent materials.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A and 1B are respectively diagrams of detecting devices with an even and a grating structure of a transparent material according to preferred embodiments of the present invention.

FIGS. 2A and 2B are respectively flowcharts of detecting devices detecting an edge of an even and a grating structure of a transparent material according to the preferred embodiments of the present invention.

FIGS. 3, 4A, 4B, 5A, 5B, 5C and 5D are respectively diagrams of a light source, a light sensor and an even and a grating structure of a transparent material in different positions according to the preferred embodiments of the present invention.

FIGS. 6A and 6B are diagrams of a transforming circuit transforming an optical intensity signal into a transforming signal for an even and a grating structure of a transparent material according to the preferred embodiments of the present invention.

FIG. 7 to FIG. 11 are respectively diagrams of the light source, the light sensor and an even and a grating structure of the transparent material in different positions according to various embodiments of the present invention.

### DETAILED DESCRIPTION

Please refer to FIGS. 1A and 1B. FIGS. 1A and 1B are diagrams of a detecting device 50 according to a preferred embodiment of the present invention. FIG. 1A illustrates a transparent material with an even structure, whereas FIG. 1B illustrates a grating structure. In FIG. 1B, the transparent grating structure 52 can be made of transparent material, such as acrylic, PVC, PET and so on, and the transparent grating structure 52 includes a planar side 521 and a cylindrical side 523. A stereoscopic image, such as an interlaced image, can be directly printed on the planar side 521. A plurality of cylindrical structures is formed on the cylindrical side 523 with equal spacing, and a plurality of convex lens is formed by convexes of the cylindrical structures so as to present different stereoscopic visual effects in different view angles. The detecting device 50 in FIGS. 1A and 1B is for detecting a position of an edge 521 of a transparent material 52 as a basis for locating. For example, the transparent material 52 can be a transparent card. As the detecting device 50 detects the transparent card, it can continue to print the card or read data of the card. For example, an Automated Teller Machine (ATM) with the detecting device 50 is capable of detecting the transparent card passing by, and then actuating a function of reading the card. The detecting device 50 includes an actuating unit 54 for driving the transparent material 52 to move in an X-direction. The detecting device 50 further includes a light source 56 for emitting light in a Y-direction to the transparent material 52 driven by the actuating unit 54. A direction (X-direction) of movement of the transparent material 52 driven by the actuating unit 54 can be substantially vertical to a direction (Y-direction) of the light emitted from the light source 56, and the light source 56 can be a light emitting diode.

The detecting device 50 further includes a light sensor 58 for sensing the light emitted from the light source 56 as the edge 521 of the transparent material 521 is moved to different positions relative to the light source 56, so as to generate a corresponding optical intensity signal. The light sensor 58 can be an optical interrupter sensor or an optical reflective sensor. In addition, the detecting device 50 further includes a transforming circuit 60 coupled to the light sensor 58 for transforming the optical intensity signal generated by the light sensor 58 into a transforming signal, such as transforming an analog signal into a recognizable digital signal. For example, level changes of the optical intensity signal generated by the light sensor 58 are weak, so the transforming circuit 60 can be utilized for amplifying the level changes of the optical intensity signal so as to generate the transforming signal. Furthermore, the detecting device 50 further includes a processing unit 62 coupled to the transforming circuit 60 for determining whether the edge 521 of the transparent material 52 is moved to a position between the light source 56 and the light sensor 58 according to the transforming signal transmitted from the transforming circuit 60.

Please refer to FIGS. 2A and 2B. FIG. 2A is a flowchart of the detecting device 50 detecting the edge 521 of the transparent material with an even structure 52 according to the preferred embodiment of the present invention. FIG. 2B is a flowchart of the detecting device 50 detecting the edge 521 of a grating structure 52 according to the preferred embodiment of the present invention. The methods include following steps:

Step 100: The actuating unit 54 drives the transparent material 52 to move in the X direction.

Step 102: The light source 56 emits the light in the Y direction to the transparent material 52 driven by the actuating unit 54.

Step 104: The light sensor 58 senses the light emitted from the light source 56 as the edge 521 of the transparent material 52 is moved to different positions relative to the light source 56 so as to generate the corresponding optical intensity signal.

Step 106: The transforming circuit 60 transforms the optical intensity signal generated by the light sensor 58 into the transforming signal.

Step 108: The processing unit 62 determines whether the edge 521 of the transparent material 52 is moved to the position between the light source 56 and the light sensor 58 according to the transforming signal transmitted from the transforming circuit 60.

Step 110: The end.

Detail description of above procedure is described herein. As the light sensor 58 is an optical interrupter sensor, the light source 56 and the light sensor 58 can be disposed at opposite sides of the transparent material 52. Please refer to FIGS. 3, 4A, 4B, 5A, 5B, 5C and 5D. FIGS. 3, 4A, 4B, 5A, 5B, 5C and 5D are respectively diagrams of the light source 56, the light sensor 58 and the transparent material 52 in different positions according to the preferred embodiment of the present invention. The actuating unit 54 can drive the transparent material 52 to move in the X direction so that the transparent material 52 can pass between the light source 56 and the light sensor 58. In some figures, in accordance with some preferred embodiments, an even structure is illustrated. In other figures, in accordance with other preferred embodiments, a grating structure is illustrated. In accordance with the present invention, all transparent materials, regardless of having an even or a grating structure, may utilize the present invention.

Returning to FIG. 3, as the transparent material 52 has not been moved to the position between the light source 56 and the light sensor 58, the light emitted from the light source 56 can totally be sensed by the light sensor 58, which means that the light sensor 58 senses stronger light, so as to generate the stronger optical intensity signal. As shown in FIGS. 4A and 4B, as the edge 521 of the transparent material 52 is moved to the position between the light source 56 and the light sensor 58, because the edge 521 of the transparent material 52 is uneven and the light travels through the interface between different media, the light emitted from the light source 56 will scatter in other directions. As a result, the light sensor 58 senses weak light so as to generate a minimum optical intensity signal, and therefore it can be a basis for determining the edge 521 of the transparent material 52 is moved to the position between the light source 56 and the light sensor 58.

As shown in FIGS. 5A, 5B, 5C and 5D, as the edge 521 of the transparent material 52 has passed through the position between the light source 56 and the light sensor 58 and the transparent material 52 itself is disposed between the light source 56 and the light sensor 58, because the transparent material 52 has a property of transparency, the light emitted from the light source 56 better penetrate the transparent material 52 and be sensed by the light sensor 58. That is, the light sensor 58 senses stronger light so as to generate the stronger optical intensity signal. In FIG. 5A, a relatively even transparent material is illustrated. As shown in FIG. 5A, the light emitted from the light source 56 can mostly penetrate the transparent material 52 and be sensed by the light sensor 58.

For a grating transparent material, as shown in FIGS. 5B, 5C and 5D, when a convex (but not the top) of the transparent grating structure 52 is moved to the position between the light source 56 and the light sensor 58, the light emitted from the light source 56 will refract due to the convex of the transparent grating structure 52 so that the light sensor 58 also senses weak light and cannot generate a maximum optical intensity signal. As shown in FIG. 5C, when the top of the transparent grating structure 52 moves to the position between the light source 56 and the light sensor 58, the light sensor 58 can sense strongest light, because the light emitted from the light source 56 directly penetrates the top of the transparent grating structure 52 almost without refraction, so as to generate the maximum optical intensity signal.

Please refer to FIGS. 6A and 6B. FIGS. 6A and 6B are diagrams of the transforming circuit 60 transforming the optical intensity signal into the transforming signal according to the preferred embodiment of the present invention. Because the level changes of the optical intensity signal generated by the light sensor 58 are weak, in order to increase accuracy of determination, the transforming circuit 60 can be utilized for amplifying the level changes of the optical intensity signal so as to generate the transforming signal. And then the processing unit 62 can determine whether the edge 521 of the transparent material 52 is moved to the position between the light source 56 and the light sensor 58 according to the transforming signal transmitted from the transforming circuit 60. That is because the edge 521 of the transparent material 52 is uneven and the light travels through the interface between different media, the light emitted from the light source 56 will scatter in other directions. As a result, the light sensor 58 senses weak light so as to generate the minimum optical intensity signal. Therefore a position of the edge 521 of the transparent material 52 can be obtained according to a waveform of the level changes of the transforming signal. For example, a wave trough of the waveform corresponds to the position of the edge 521 of the transparent material 52, and it can be a basis for determining the edge 521 of the transparent material 52 is moved to the position between the light source 56 and the light sensor 58.

For a grating transparent material, the processing unit 62 can determine the position of every grating of the transparent grating structure 52 according to the transforming signal transmitted from the transforming circuit 60. For example, every grating of the transparent grating structure 52 respectively corresponds to a level change of the optical intensity signal, which means that the top of the transparent grating structure 52 corresponds to the maximum optical intensity signal and the other portions of the transparent grating structure 52 correspond to weaker optical intensity signals. Positions and amounts of the gratings of the transparent grating structure 52 can be determined according to a waveform of level changes of the transforming signal, for providing a basis of locating and printing the stereoscopic image in following procedure.

Moreover, the light sensor 58 of the present invention can selectively be an optical reflective sensor. Please refer to FIG. 7 to FIG. 9. FIG. 7 to FIG. 9 are respectively diagrams of the light source 56, the light sensor 58 and the transparent material 52 in different positions according to another embodiment of the present invention. The difference between this embodiment and the previous one is that the light source 56 and the light sensor 58 are both disposed at the same side of the transparent material 52 in this embodiment. As shown in FIG. 7, as the transparent material 52 has not been moved to the position between the light source 56 and the light sensor 58, the light emitted from the light source 56 totally cannot be sensed by the light sensor 58, which means that the light sensor 58 senses weaker light so as to generate a weaker optical intensity signal. As shown in FIG. 8, as the edge 521 of the transparent material 52 is moved to the position between the light source 56 and the light sensor 58, because the edge 521 of the transparent material 52 is uneven and the light travels through the interface between different media, the light emitted from the light source 56 will scatter in other directions. As a result, the light sensor 58 can sense the scattering light so as to generate a maximum optical intensity signal, and therefore it can be a basis for determining the edge 521 of the transparent material 52 is moved to the position between the light source 56 and the light sensor 58. As shown in FIG. 9, as the edge 521 of the transparent material 52 has passed through the position between the light source 56 and the light sensor 58, and the transparent material 52 itself is disposed between the light source 56 and the light sensor 58, because the transparent material 52 has a property of transparency, the light emitted from the light source 56 can mostly penetrate the transparent material 52 and cannot be sensed by the light sensor 58. That is, the light sensor 58 senses weaker light so as to generate the weaker optical intensity signal.

Similarly, the light sensor 58 acing as an optical reflective sensor may be utilized for a grating structure as well. As shown in FIG. 10, the detecting device 50 according to another embodiment of the present invention is shown. The difference between this embodiment and previous one is that the light source 56 and the light sensor 58 are both disposed in front of the cylindrical side 523 of the transparent grating structure 52 in this embodiment. Similar to the previous embodiment, when the convex (not the top) of the transparent grating structure 52 is moved to a position corresponding to the light source 56, the light sensor 58 senses stronger reflective light because the convex of the transparent grating structure 52 reflects the light emitted from the light source 56, and therefore the light sensor 58 generates the stronger optical intensity signal. But when the top of the transparent grating structure 52 is moved to the position corresponding to the light source 56, the light sensor 58 senses weaker light because most of the light emitted from the light source 56 penetrates the top of the transparent grating structure 52 and there is almost no reflective light, so that the light sensor 58 generates the minimum optical intensity signal.

As for the operational principle of the transforming circuit 60 and the processing unit 62 is similar to the previous embodiments and is thus omitted herein for simplicity. Furthermore, the positions and amounts of the light source 56 and the light sensor 58 are not limited to above embodiments. For example, the present invention can include multiple sets of light sources and light sensors, and those components can be disposed at two ends of a travelling path of the transparent material 52 respectively, so as to locate the transparent material 52 more accurately, and it depends on practical design demand.

In contrast to the prior art, the methods for detecting an edge of a transparent material and detecting devices and systems for same of the present invention can utilize the light sensor and the transforming circuit to detect and locate the edge of the transparent material directly for following locating procedure. There is no need to execute additional process on the transparent material to achieve the purpose of sensing the transparent material by the light sensor. For example, there is no need to print the stereoscopic image on an opaque substrate, such as photographic paper or cards and so on, and then to stick the transparent grating plate on the substrate. That is, the step of configuring the substrate and sticking the transparent plate on the substrate can be omitted. The stereoscopic image can be directly printed on the planar side of the transparent grating plate, so as to reduce manufacturing difficulty and cost greatly. As a result, the manufacturing cost and difficulty can be reduced, and products with the transparent material as a substrate can be widely applied in identification.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detecting device comprising:
an actuating unit for driving a transparent material;
a light source for emitting light to the transparent material driven by the actuating unit;
a light sensor for sensing the light emitted from the light source as an edge of the transparent material is moved to different positions relative to the light source so as to generate a corresponding optical intensity signal;
a transforming circuit coupled to the light sensor for transforming the optical intensity signal into a transforming signal; and
a processing unit coupled to the transforming circuit for determining whether the edge of the transparent material is moved to a position between the light source and the light sensor according to the transforming signal transmitted from the transforming circuit.

2. The detecting device of claim 1, wherein the light source is a light emitting diode, and the light sensor is an optical interrupter sensor.

3. The detecting device of claim 2, wherein the light source and the light sensor are disposed at opposite sides of the transparent material.

4. The detecting device of claim 2, wherein the light emitted from the light source is scattered by the edge of the transparent material as the edge of the transparent material is moved to the position between the light source and the light sensor so as to generate the minimum optical intensity signal by the light sensor.

5. The detecting device of claim 1, wherein the light source is a light emitting diode, and the light sensor is an optical reflective sensor.

6. The detecting device of claim 5, wherein the light source and the light sensor are disposed at the same side of the transparent material.

7. The detecting device of claim 5, wherein the light emitted from the light source is scattered by the edge of the transparent material as the edge of the transparent material is moved to the position between the light source and the light sensor so as to generate the maximum optical intensity signal by the light sensor.

8. The detecting device of claim 1, wherein the transforming circuit is for amplifying level changes of the optical intensity signal so as to generate the transforming signal.

9. The detecting device of claim 1, wherein a direction of movement of the transparent material driven by the actuating unit is substantially vertical to a direction of the light emitted from the light source.

10. A method for detecting an edge of a transparent material, comprising:
driving the transparent material;
a light source emitting light to the transparent material;
a light sensor sensing the light emitted from the light source as the transparent material is moved to different positions relative to the light source so as to generate a corresponding optical intensity signal;
transforming the optical intensity signal generated by the light sensor into a transforming signal; and
determining whether the edge of the transparent material is moved to a position between the light source and the light sensor according to the transforming signal.

11. The method of claim 10, further comprising disposing the light source and the light sensor at opposite sides of the transparent material.

12. The method of claim 11, wherein the light emitted from the light source is scattered by the edge of the transparent material as the edge of the transparent material is moved to the position between the light source and the light sensor so as to generate the minimum optical intensity signal by the light sensor.

13. The method of claim 10, further comprising disposing the light source and the light sensor at the same side of the transparent material.

14. The method of claim 13, wherein the light emitted from the light source is scattered by the edge of the transparent material as the edge of the transparent material is moved to the position between the light source and the light sensor so as to generate the maximum optical intensity signal by the light sensor.

15. The method of claim 11, wherein transforming the optical intensity signal into the transforming signal comprises amplifying level changes of the optical intensity signal so as to generate the transforming signal.

16. The method of claim 11, wherein a direction of driving the transparent material is substantially vertical to a direction of the light emitted from the light source.

17. A system capable of detecting a transparent material comprising:
a detecting device including an actuating unit for driving a transparent material; a light source for emitting light to the transparent material driven by the actuating unit; a light sensor for sensing the light emitted from the light source as an edge of the transparent material is moved to different positions relative to the light source so as to generate a corresponding optical intensity signal; a transforming circuit coupled to the light sensor for transforming the optical intensity signal into a transforming signal; and a processing unit coupled to the transforming circuit for determining whether the edge of the transparent material is moved to a position between the light source and the light sensor according to the transforming signal transmitted from the transforming circuit.

18. A system capable of detecting both transparent as well as non-transparent materials comprising:
a detecting device including an actuating unit for driving a transparent material; a light source for emitting light to the transparent material driven by the actuating unit; and a light sensor for sensing the light emitted from the light source as an edge of the transparent material is moved to different positions relative to the light source so as to generate a corresponding optical intensity signal;
wherein according to the optical intensity signal, the detecting device may determine whether the material is transparent or non-transparent.

19. A system capable of printing onto a transparent material comprising:
a detecting device including an actuating unit for driving a transparent material; a light source for emitting light to the transparent material driven by the actuating unit; a light sensor for sensing the light emitted from the light source as an edge of the transparent material is moved to different positions relative to the light source so as to generate a corresponding optical intensity signal; a transforming circuit coupled to the light sensor for transforming the optical intensity signal into a transforming signal; and a processing unit coupled to the transforming circuit for determining whether the edge of the transparent material is moved to a position between the light source and the light sensor according to the transforming signal transmitted from the transforming circuit;
wherein based on the position determined by the processing unit, the system may print onto the transparent material.

20. A system capable of printing onto both a non-transparent material as well as a transparent material comprising:
a detecting device including an actuating unit for driving the transparent or non-transparent material; a light source for emitting light to the transparent or non-transparent material driven by the actuating unit; a light sensor for sensing the light emitted from the light source as an edge of the transparent or non-transparent material is moved to different positions relative to the light source so as to generate a corresponding optical intensity signal; a transforming circuit coupled to the light sensor for transforming the optical intensity signal into a transforming signal; and a processing unit coupled to the transforming circuit for determining whether the edge of the transparent material is moved to a position between the light source and the light sensor according to the transforming signal transmitted from the transforming circuit;
wherein according to the optical intensity signal, the detecting device may determine whether the material is transparent or non-transparent and based on the position determined by the processing unit, the system may print onto the transparent material.
